(19) United States
(12) Patent Application Publication
(10) Pub. No.: US 2006/0078267 A1
(43) Pub. Date: Apr. 13, 2006

(54) Light illuminating unit and liquid crystal display device having the same

(76) Inventors: Jae-Lok Cha, Goyang-si (KR); Kyoung-Don Lee, Suwon-si (KR)

Correspondence Address: CANTOR COLBURN, LLP, 55 GRIFFIN ROAD SOUTH, BLOOMFIELD, CT, 06002, US

(21) Appl. No.: 11/247,794

(22) Filed: Oct. 10, 2005

(30) Foreign Application Priority Data
Oct. 12, 2004 (KR) 2004-81381

(51) Int. Cl. G02B 6/10

(52) U.S. Cl. 385/146

(57) ABSTRACT

A light illuminating unit includes light generating members and a light guiding plate. Each of the light generating members generates light. The light generating members include an LED. The light guiding plate includes a light-incident face onto which the light is incident, a lateral face facing the light-incident face, and a light-exiting face through which the incident light exits. The light-exiting face being configured to connect the light-incident face and the lateral face. An interval between the light-incident face and the lateral face varies in accordance with a position of each of the light generating members. Thus, a number of LEDs decreases, so that an assembly process of the light illuminating unit may be simplified, and manufacturing cost and power consumption thereof may be reduced.

### CROSS-REFERENCE TO RELATED APPLICATIONS

This application claims priority to Korean Patent Application No. 2004-81381 filed on Oct. 12, 2004, and all the benefits accruing therefrom under 35 U.S.C. § 119, the contents of which are herein incorporated by reference in its entirety.

### BACKGROUND OF THE INVENTION

1. Field of the Invention

The present invention relates to a light illuminating unit, and a liquid crystal display device having the light illuminating unit.

2. Description of the Related Art

Generally, liquid crystal has both electrical and optical characteristics. A liquid crystal display (“LCD”) device displays an image using the liquid crystal. The LCD device has various characteristics, for example, relatively thin thickness, small volume, and lightweight compared to a cathode ray tube (“CRT”). Thus, the LCD device is widely used in various electrical instruments, such as portable computers, communication devices, and television sets, etc.

The LCD device includes a liquid crystal controlling part that controls the liquid crystal and a light providing part that provides the liquid crystal controlling part with light. Particularly, the LCD device includes an LCD panel serving as the liquid crystal controlling part and a backlight assembly serving as the light providing part. The backlight assembly includes a light emitting diode (“LED”) and a light guiding plate. The light guiding plate guides the light emitted from the LED.

The backlight assembly provides the LCD panel with a planar light having a uniform luminance. When the light from the backlight assembly is incident into the LCD panel, an image is uniformly displayed on an effective display region of the LCD panel. Light distribution uniformity, for example, is influenced by a shape of the light guiding plate, a position of the LED, etc.

When the number of LEDs is insufficient to emit light for an image and thus the light emitted from the LEDs is not applied to a display region sufficiently, a dark portion is generated at the display region. To eliminate the dark portion, the LCD device requires at least a certain number of LEDs.

Therefore, the power consumption and manufacturing cost increases for LCD configurations having a multitude of LEDs.

### SUMMARY OF THE INVENTION

The present invention provides a light illuminating unit that obviates the above problems. The present invention also provides a liquid crystal display device having the above-mentioned light illuminating unit.

In one aspect of the present invention, a light illuminating unit includes a plurality of light generating members and a light guiding plate. Each of the light generating members generates light. The light generating members, for example, include an LED. The light guiding plate includes a light-incident face onto which the light is incident, a lateral face facing the light-incident face, and a light-exiting face through which the incident light exits. The light-exiting face being configured to connect the light-incident face and the lateral face. Here, an interval between the light-incident face and the lateral face varies in accordance with a position of each of the light generating members. For example, the light-incident face includes a first face substantially parallel with the lateral face, a second face formed adjacent to a first end portion of the first face and slanted with respect to the first face, and a third face formed adjacent to a second end portion of the first face and slanted with respect to the first face. The light-incident face may include a first light-incident face and a second light-incident face formed adjacent to the first light-incident face. In addition, the light-incident face may further include a third light-incident face formed adjacent to the second light-incident face. The light generating members may be disposed to irradiate light onto the first face, the second face, and the third face. Alternatively, the light generating members may be disposed to irradiate light onto the second and third faces.

In another aspect of the present invention, a light illuminating unit includes at least first and second light generating members and a light guiding plate. Each of the light generating members generates light. The light guiding plate includes a light-incident face onto which the light is incident and a light-exiting face through which the incident light exits. The light-exiting face has an effective exiting region through which the light substantially exits. The light-incident face has a slanted face such that the light generated from the first light generating member overlaps a portion of light from the second light generating member at least when the light enters the effective exiting region.

In still another aspect of the present invention, an LCD device includes a light generating part, a light guiding plate, an LCD panel, and a receiving container. The light generating part includes a plurality of light generating members for generating light. The light guiding plate includes a light-incident face onto which the light is incident, a lateral face facing the light-incident face, and a light-exiting face through which the incident light exits. The light-exiting face being configured to connect the light-incident face and the lateral face. Here, an interval between the light-incident face and the lateral face varies in accordance with a position of each of the light generating members. The LCD panel displays an image using the light from the light guiding plate. The receiving container receives the light generating part, the light guiding plate, and the LCD panel.

According to the above, the LEDs are angularly disposed at predetermined angles such that the light emitted from the LEDs advances in different directions, thereby reducing the number of LEDs employed as a light generating part. Thus, an assembly process of the light illuminating unit having LEDs may be simplified, and manufacturing cost and power consumption thereof may be reduced.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is an exploded perspective view illustrating an exemplary embodiment of a light illuminating unit in accordance with the present invention;

FIGS. 2 to 4 are plan views illustrating optical paths in the light illuminating unit of FIG. 1;

FIG. 5 is an exploded perspective view illustrating another exemplary embodiment of a light illuminating unit in accordance with the present invention;

FIG. 6 is a plan view illustrating an optical path in the light illuminating unit of FIG. 5;

FIG. 7 is a plan view illustrating another exemplary embodiment of a light illuminating unit in accordance with the present invention;

FIG. 8 is a plan view illustrating another exemplary embodiment of a light illuminating unit in accordance with the present invention; and

FIG. 9 is an exploded perspective view illustrating an exemplary embodiment of a liquid crystal display device in accordance with the present invention.

### DETAILED DESCRIPTION OF THE EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like reference numerals refer to similar or identical elements throughout.

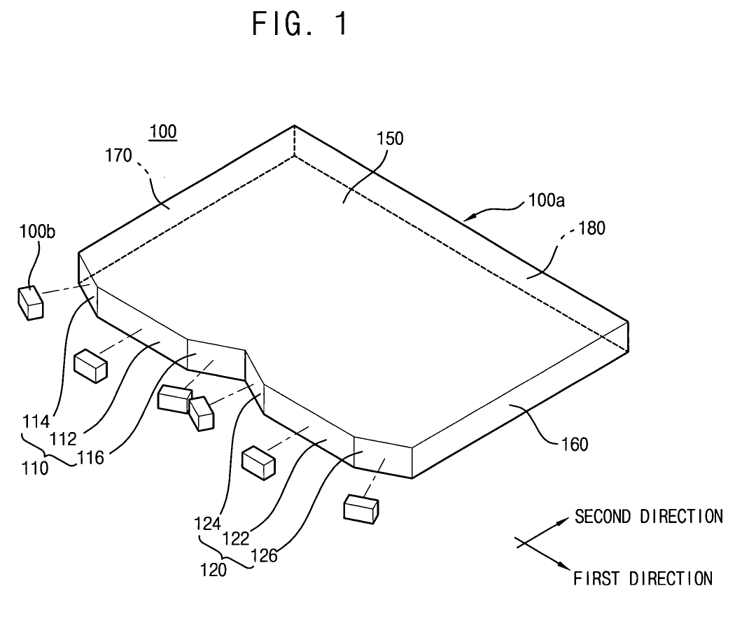

FIG. 1 is an exploded perspective view illustrating an exemplary embodiment of a light illuminating unit in accordance with the present invention.

Referring to FIG. 1, a light illuminating unit 100 includes a light guiding plate 100a and a plurality of LEDs 100b. In the present embodiment, since the LEDs 100b have a substantially same function and structure with each other, one LED will be described in detail.

An LED 100b generates light in response to a power voltage externally provided. In the present embodiment, for example, the LED 100b includes a white LED that emits white light. In alternative embodiments, the LED 100b may include a red LED that emits a red light, a green LED that emits a green light, and/or a blue LED that emits a blue light. Here, the red, green and blue LEDs may emit a white light at a predetermined combination ratio thereof. The LED 100b is electrically connected to a printed circuit board (“PCB”) (not shown) configured to receive the power voltage.

The light guiding plate 100a may have a substantially flat and polygonal plate shape of a predetermined width. The light guiding plate 100a guides light emitted from the LEDs 100b along a substantially horizontal direction and then emits the light. The light guiding plate 100a converts linear light generated from the LEDs 100b into planar light. The light guiding plate 100a includes a first light-incident face 110, a second light-incident face 120, a light-exiting face 150, a first lateral face 160, a second lateral face 170, and a third lateral face 180.

The light emitted from the LED 100b is incident onto the first light-incident face 110. An interval between the first light-incident face 110 and the third lateral face 180 varies in accordance with a position of each of the LEDs 100b. For example, the first light-incident face 110 includes a first face 112, a second face 114, and a third face 116. The first face 112 is disposed substantially parallel with respect to the third lateral face 180. That is, the first face 112 is disposed substantially parallel with respect to a first direction shown in FIG. 1. The LED 100b providing the first face 112 with light may be placed at a center portion of the first face 112. The second face 114 is formed adjacent to a left side of the first face 112 in its front view, and is slanted toward the first face 112. The third face 116 is formed adjacent to a right side of the first face 112 in its front view, and is slanted toward the first face 112. Thus, each of the second and third faces 114 and 116 is disposed at a predetermined angle with respect to the first direction. The second and third faces 114 and 116 are substantially symmetrical to each other with respect to an axis that passes through a center of the first face 112 where the axis is substantially parallel with a second direction in FIG. 1. The second direction is substantially perpendicular to the first direction. The LEDs 100b positioned at the first, second, and third faces 112, 114, and 116, each emit light incident onto the first, second, and third faces 112, 114, and 116, respectively.

The second light-incident face 120 is formed adjacent to the first light-incident face 110. The second light-incident face 120 has a shape substantially similar to that of the first light-incident face 110. Thus, an interval between the second light-incident face 120 and the third lateral face 180 varies in accordance with the position of the LEDs 100b. The second light-incident face 120 includes a first face 122 disposed substantially parallel with the first direction, a second face 124 and a third face 126 disposed at predetermined angles with respect to the first direction and the first face 122. The LED 100b providing light to the first face 122 of the second light-incident face 120 may be placed at a center portion of the first face 122. The second and third faces 124 and 126 are substantially symmetrical to each other with respect to an axis that passes through a center of the first face 122 where the axis is substantially parallel with the second direction. Similar to the first light-incident face 110, the LEDs 100b positioned at the first, second, and third faces 122, 124, and 126 of the second light-incident face 120, each emit light incident onto the first, second, and third faces 122, 124, and 126, respectively.

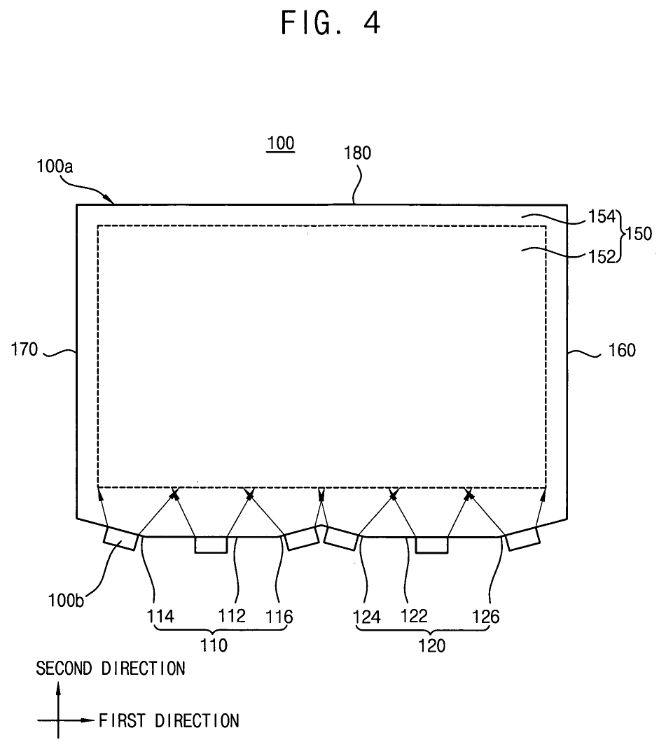

The light incident onto the first and second light-incident faces 110 and 120 is emitted from the light-exiting face 150. Particularly, the light emitted from the LEDs 100b is incident onto the first and second incident faces 110 and 120, and then the light is uniformly reflected in the light guiding plate 100a having a relatively wide area to form planar light. Thus, the planar light is emitted from the light-exiting face 150. The light-exiting face 150 has an effective exiting region 152 and a noneffective exiting region 154, best illustrated in FIG. 4, the plan view of FIG. 1. The light incident onto the first and second light-incident faces 110 and 120 may be substantially emitted through the entire effective exiting region 152. The incident light may not substantially exit through the noneffective exiting region 154. Thus, the noneffective exiting region 154 cannot be used as a display area.

The first lateral face 160 and the second lateral face 170 are formed adjacent to the second light-incident face 120 and the first light-incident face 110, respectively. The first and second lateral faces 160 and 170 face each other. The third lateral face 180 faces the first and second light-incident faces 110 and 120, respectively.

The light guiding plate 100a may have a flat plate-like shape, so that the light guiding plate 100a has a substantially uniform thickness from the first and second light-incident faces 110 and 120 to the third lateral face 180 facing the first and second light-incident faces 110 and 120. Alternatively, the light guiding plate 100a may have a wedge shape, for example, where a thickness of the light guiding plate 100a may be gradually thinner from the first and second light-incident faces 110 and 120 to the third lateral face 180 facing the first and second light-incident faces 110 and 120.

Hereinafter, optical paths in the light illuminating unit 100 will be described in detail with reference to the accompanying drawings.

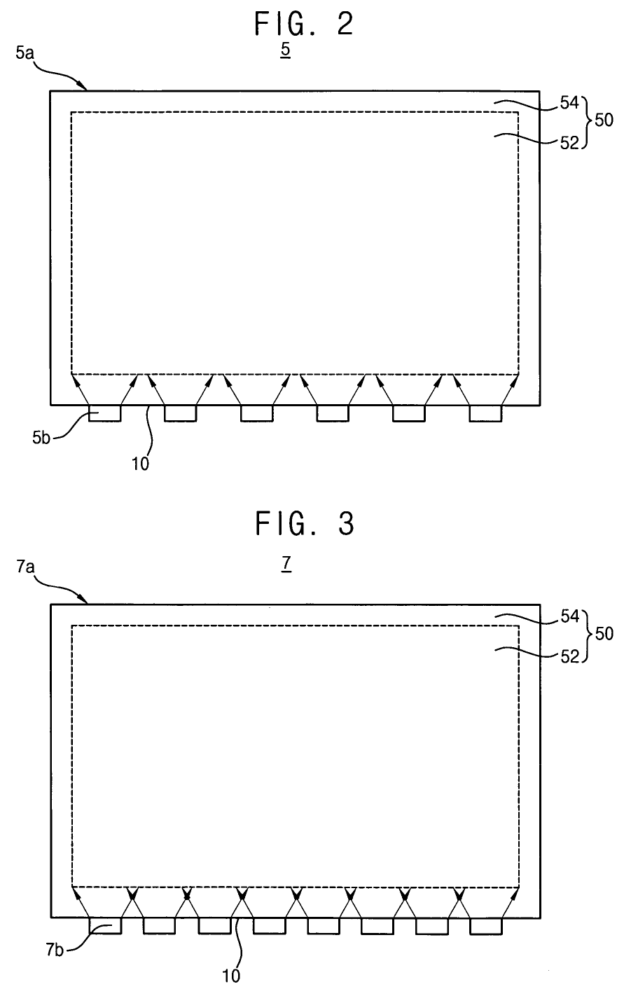

Referring to FIGS. 2 to 4, plan views each illustrate optical paths in an light illuminating unit. FIG. 2 is a plan view illustrating an optical path in a light illuminating unit 5 having a substantially flat light-incident face 10 and having a substantially similar number of LEDs as in FIG. 1. FIG. 3 is a plan view illustrating an optical path in a light illuminating unit 7 having a substantially flat light-incident face 10 and having more LEDs than in FIG. 1. FIG. 4 is a plan view illustrating an optical path in the light illuminating unit 100 in FIG. 1.

Referring to FIG. 2, a light illuminating unit 5 includes a substantially similar number of LEDs 5b as the light illuminating unit 100 in FIG. 1. When light emitted from the LEDs 5b is incident onto a substantially flat light-incident face of a light guiding plate 5a, the light from one LED does not overlap with light from another LED before the light arrives at the effective exiting region 52. Thus, a dark portion is formed on a boundary portion of the effective exiting region 52 near the LEDs 5b. The dark portion means a portion into which the light is not provided and through which the light does not exit. When a distance between the LEDs 5b and the effective exiting region 52 increases, a side of the dark portion may be reduced. In order to increase the distance between the LEDs 5b and the effective exiting region 52, the effective exiting region 52 needs to be reduced or a size of the light guiding plate 5a needs to be increased.

Referring to FIG. 3, a light illuminating unit 7 includes more LEDs 7b than the light illuminating unit 100 in FIG. 1. With the addition of more LEDs, when light emitted from the LEDs 7b is incident onto a substantially flat light-incident face of a light guiding plate 7a, the light from one LED overlaps with a portion of light from another LED before the light arrives at the effective exiting region 52. Thus, substantially no dark portion is formed on a boundary portion near the LEDs 7b of the effective exiting region 52. However, the light illuminating unit 7 includes more LEDs than the light illuminating unit 5 in FIG. 2, so that a process of manufacturing the light illuminating unit 7 may be more complicated including increased manufacturing cost and power consumption.

Referring to FIG. 4, light emitted from the LEDs 100b is incident onto the first light-incident face 110 and the second light-incident face 120. The incident light advances along a predetermined angle in accordance with the Snell's law.

The light incident onto the first face 112, second face 114, and third face 116 of the first light-incident face 110 advances, for example, along an angle of about seventy degrees to about eighty degrees. The first face 112 is disposed substantially parallel with respect to the first direction, and the second and third faces 114 and 116 are disposed at predetermined angles with respect to the first direction and the first face 112. Thus, when the light incident onto the second and third faces 114 and 116 is incident onto the effective exiting region 152, the light is incident onto a portion wider than that of light emitted from a first light-incident face without a slanted face (e.g. the light-incident face 10 in FIG. 2).

A path of the light incident onto the first face 122, second face 124, and third face 126 of the second light-incident face 120 is substantially similar to the path of the light incident onto the first, second, and third faces 112, 114, 116 of the first light-incident face 110.

When compared with the path shown in FIG. 2, the light illuminating unit 100 of FIG. 4 employs a substantially similar number of LEDs as the light illuminating unit 5 in FIG. 2. However, since the light incident onto the light-incident face may overlap at least when the light is incident onto the effective exiting region 152, the light illuminating unit 100 has substantially no dark portion at the boundary portion near the LEDs 100b of the effective exiting region 152. Thus, the light-exiting face 150 in FIG. 4 has the noneffective exiting region 154 smaller than that 54 of the light-exiting face 50 in FIG. 2.

When compared with the optical path shown in FIG. 3, the light illuminating unit 100 of FIG. 4 has a substantially similar size of the effective exiting region 152 and a substantially similar size of the noneffective exiting region 154 compared to those 52 and 54 of the light illuminating unit 7 in FIG. 3. However, the light illuminating unit 100 in FIG. 4 includes fewer LEDs than the light illuminating unit 7 in FIG. 3. According to the present embodiment, the LEDs in FIG. 4 are disposed at predetermined angles such that the light emitted from the LEDs 100b advances in a different direction, thereby reducing the number of the LEDs 100b. Thus, manufacturing the light illuminating unit 100 having fewer LEDs 100b is simplified, and manufacturing cost and power consumption thereof are reduced. In addition, the noneffective exiting region 154 decreases when configuring the LEDs 100b as described so that a size of the light illuminating unit 100 and a size of the LCD employing the light illuminating unit 100 may decrease.

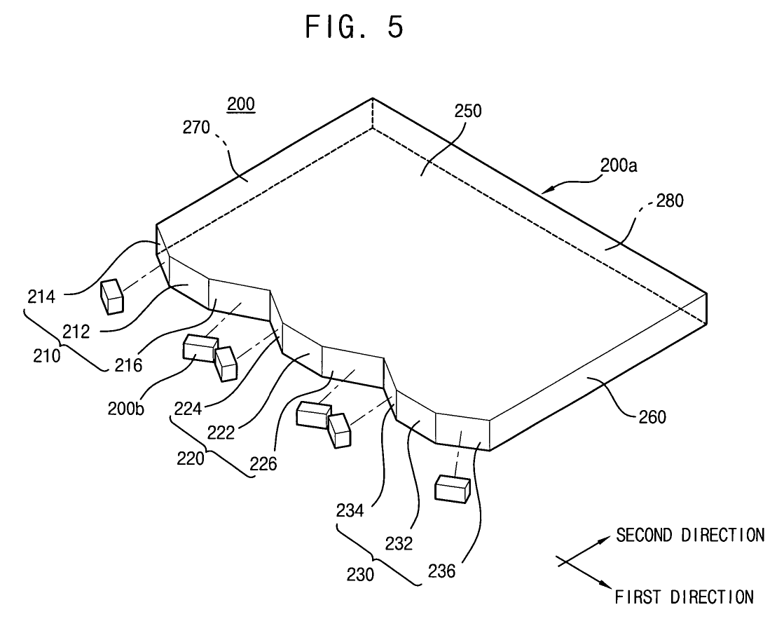

FIG. 5 is an exploded perspective view illustrating another exemplary embodiment of a light illuminating unit in accordance with the present invention.

The light illuminating unit 200 is substantially similar to the light illuminating unit 100 in FIG. 1, except for the configuration of light-incident faces. Thus, any further description of substantially similar elements will be omitted.

The light illuminating unit 200 includes a light guiding plate 200a and a plurality of LEDs 200b. The light guiding plate 200a includes a first light-incident face 210, a second light-incident face 220, a third light-incident face 230, a light-exiting face 250, a first lateral face 260, a second lateral face 270, and a third lateral face 280.

The light emitted from the LEDs 200b is incident onto the first light-incident face 210. An interval between the first light-incident face 210 and the third lateral face 280 varies in accordance with a position of each of the LEDs 200b. For example, the first light-incident face 210 includes a first face 212, a second face 214, and a third face 216. The first face 212 is disposed substantially parallel with the third lateral face 280. That is, the first face 212 is disposed substantially parallel with a first direction shown in FIG. 5. Substantially no light is provided to the first face 212 in the present embodiment. In an alternative embodiment, an LED providing the first face 212 with light may be placed at a center portion of the first face 212. The second face 214 is formed adjacent to a left side of the first face 212 in its front view and is slanted toward the first face 212. The third face 216 is formed adjacent to a right side of the first face 212 in its front view and is slanted toward the first face 212. Thus, each of the second and third faces 214 and 216 is disposed at a predetermined angle with respect to the first direction. The second and third faces 214 and 216 are substantially symmetrical to each other with respect to an axis that passes through a center of the first face 212 where the axis is substantially parallel with respect to a second direction. The second direction is substantially perpendicular to the first direction. The LEDs 200b positioned at the second and third faces 214 and 216 each emit light incident onto the second and third faces 214 and 216.

The second light-incident face 220 is formed adjacent to the first light-incident face 210. The third light-incident face 230 is formed adjacent to the second light-incident face 220. Each of the second and third light-incident faces 220 and 230 has a configuration substantially similar to that of the first light-incident face 210. Thus, an interval between each of the second and third light-incident faces 220 and 230 and the third lateral face 280 varies in accordance with the position of each of the LEDs 200b. The second and third light-incident faces 220 and 230 include first faces 222 and 232, respectively, substantially parallel with respect to the first direction. The second and third light-incident faces 220 and 230 also have second faces 224 and 234 and third faces 226 and 236, respectively, disposed at predetermined angles with respect to the first direction and first faces 222 and 232, respectively. The second faces 224 and 234 and the third faces 226 and 236 are substantially symmetrical to each other with respect to an axis that passes through a center of the respective first face 222, 232 where the axis is substantially parallel with respect to the second direction, respectively. Similar to the first light-incident face 210, the LEDs 200b positioned near the second and third faces 224 and 226 of the second light-incident face 220, each emit light incident onto the second and third faces 224, 226. Similarly, the LEDs 200b positioned near the second and third faces 234 and 236 of the third light-incident face 230, each emit light incident onto the second and third faces 234, 236.

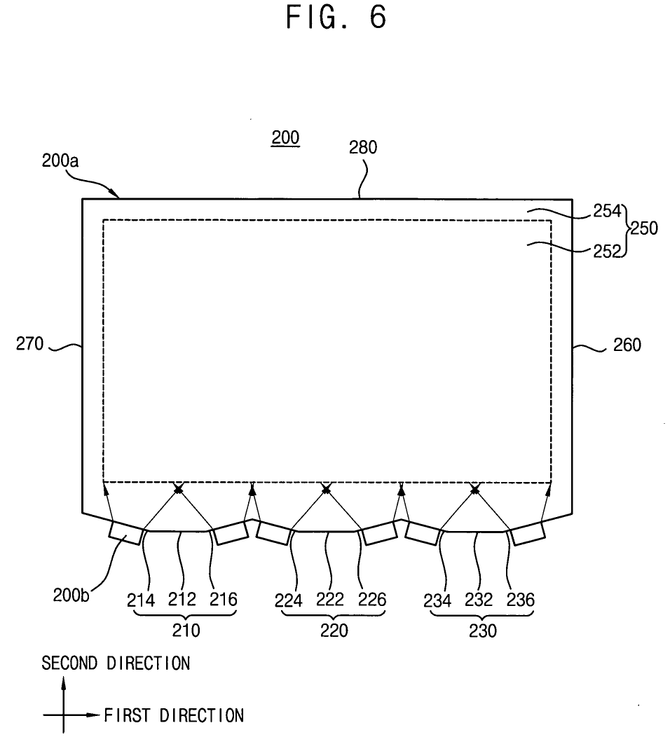

Referring to FIG. 6, an optical path in the light illuminating unit 200 in FIG. 5 will now be described. The light incident onto the first, second, and third light-incident faces 210, 220, and 230 is emitted from the light-exiting face 250. The light-exiting face 250 has an effective exiting region 252 and a noneffective exiting region 254. The light incident onto the first, second, and third light-incident faces 210, 220, and 230 is substantially emitted from the entire effective exiting region 252. The incident light may not substantially exit through the noneffective exiting region 254.

FIG. 6 is a plan view illustrating an optical path in the light illuminating unit of FIG. 5.

Light emitted from the LEDs 200b is incident onto the first light-incident face 210, the second light-incident face 220, and the third light-incident face 230. The incident light advances along a predetermined angle in accordance with the Snell's law.

The light incident onto the first face 212, second face 214, and third face 216 of the first light-incident face 210 advances, for example, along an angle of about seventy degrees to about eighty degrees. The first face 212 is disposed substantially parallel with respect to the first direction, and the second and third faces 214 and 216 are disposed at predetermined angles with respect to the first direction and the first face 212. Thus, when the light incident onto the second and third faces 214 and 216 is incident onto the effective exiting region 252, the light is incident onto a portion wider than that of light emitted from a light-incident face without a slanted face. In this embodiment, the first face 212 has a length with respect to the first direction such that the light emitted from each of the LEDs 200b may overlap with light from another LED at least when the light is incident on the effective exiting region 252.

A path of the light incident onto the second face 224 and third face 226 of the second light-incident face 220, and a path of the light incident onto the second face 234 and third face 236 of the third light-incident face 230 are substantially similar to the path of light incident onto the second and third faces 214 and 216 of the first light-incident face 210.

When comparing paths of light of the light illuminating unit 200 in FIG. 6 with paths of light of the light illuminating unit 5 shown in FIG. 2, the light illuminating unit 200 employs a substantially similar number of LEDs as the light illuminating unit 5 in FIG. 2. However, since the light from one LED can overlap with a portion of light from another LED at least when the light is incident onto the effective exiting region 252, the light illuminating unit 200 substantially has no dark portion formed on a boundary portion near the LEDs 200b of the effective exiting region 252. Thus, the light-exiting face 250 in FIG. 6 has the noneffective exiting region 254 smaller than that of the light-exiting face 50 in FIG. 2.

When comparing the light illuminating unit 7 in FIG. 3, with the light illuminating unit 200 of FIG. 6, both have a substantially similar size of the effective exiting region 252 and a substantially similar size of the noneffective exiting region 254. However, the light illuminating unit 200 in FIG. 6 includes fewer LEDs 200b than the light illuminating unit 7 in FIG. 3. The LEDs 200b used in the light illuminating unit 200 are disposed at predetermined angles such that the light emitted from each of the LEDs 200b advances in a direction incident onto the effective exiting region 252 in an overlapping manner. This configuration reduces the number of LEDs 200b required to provide a substantial amount of light to the effective exiting region 252 and substantially eliminate the dark portion where the light does not overlap. In addition, the LEDs 200b are disposed only on the slanted face, thereby augmenting a size of the effective exiting region 252 and reducing a size of the light illuminating unit 200.

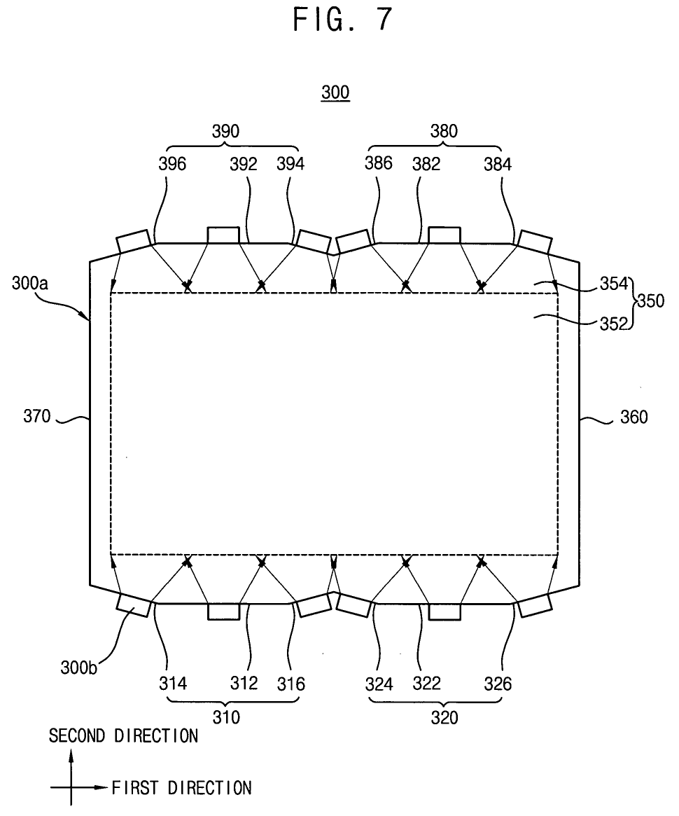

FIG. 7 is a plan view illustrating another exemplary embodiment of a light illuminating unit in accordance with the present invention.

Referring to FIG. 7, an optical path in a light illuminating unit 300 is provided. The light illuminating unit 300 is substantially similar to the light illuminating unit 100 in FIG. 1, except the lateral face 180 is configured to receive LEDs. Thus, any further description of substantially similar elements will be omitted.

The light illuminating unit 300 includes a light guiding plate 300a and a plurality of LEDs 300b. The light guiding plate 300a includes a first light-incident face 310, a second light-incident face 320, a light-exiting face 350, a first lateral face 360, a second lateral face 370, a third light-incident face 380, and a fourth light-incident face 390.

The third and fourth light-incident faces 380 and 390 are formed at position corresponding to the third lateral face 180 of the light illuminating unit 100 in FIG. 1.

The third and fourth light-incident faces 380 and 390 have a configuration substantially symmetrical to the first and second light-incident faces 310 and 320 with respect to the light guiding plate 300a. Thus, the third and fourth light-incident faces 380 and 390 are formed adjacent to each other. The third and fourth light-incident faces 380 and 390 include first faces 382 and 392, second faces 384 and 394, and third faces 386 and 396, respectively. The first faces 382 and 392 are disposed substantially parallel with respect to a first direction as shown in FIG. 7. The second faces 384 and 394 and third faces 386 and 396 are disposed at predetermined angles with respect to the first direction and the first faces 382 and 392, respectively. The LEDs 300b providing the first faces 382 and 392 with light may be placed at a center portion of the first faces 382 and 392. The second faces 384 and 394 and third faces 386 and 396 are substantially symmetrical to each other with respect to an axis that passes through a center of the first faces 382 and 392, respectively, where the axis is substantially parallel with respect to the second direction. The LEDs 300b positioned at the first, second, and third faces 382, 384, and 386 of the third light-incident face 380, each emit light incident onto the first, second, and third faces 382, 384, and 386, of the third light-incident face 380. Similarly, the LEDs 300b positioned at the first, second, and third faces 392, 394, and 396 of the fourth light-incident face 390, each emit light incident onto the first, second, and third faces 392, 394, and 396, respectively, of the fourth light-incident face 390. In the present embodiment, the third and fourth light-incident faces 380 and 390 of FIG. 7 have a configuration substantially similar to the first and second light-incident faces 110 and 120 of the light illuminating unit 100 in FIG. 4, except the third and fourth light-incident faces 380 and 390 are formed facing the first and second light-incident faces 310 and 320 in FIG. 7. In another alternative embodiment, the light illuminating unit 300 can include a light guiding plate 300a having light-incident faces formed in a facing spaced manner similar to that shown in FIG. 7, except where the light-incident faces have a configuration substantially similar to the first, second, and third light-incident faces 210, 220, and 230, respectively, of the light illuminating unit 200 in FIG. 5. In yet another alternative embodiment, the light illuminating unit 300 can include a light guiding plate 300a having light-incident faces formed in a facing spaced manner similar to that in FIG. 7, except the light-incident faces on one side have a configuration similar to the light-incident faces 110 and 120 of the light illuminating unit 100 in FIG. 4, and the other side has light-incident faces configured similar to the light-incident faces 210, 220, and 230 of the light illuminating unit 200 in FIG. 5. Accordingly, the luminance of light emitted from the light-exiting face 350 increases and the uniformity of the light is enhanced.

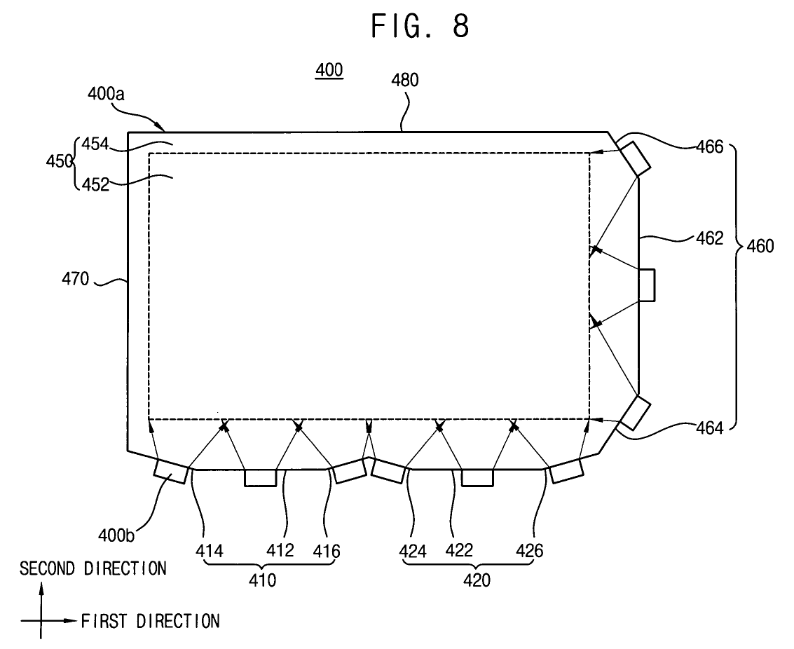

FIG. 8 is a plan view illustrating another exemplary embodiment of a light illuminating unit in accordance with the present invention.

Referring to FIG. 8, an optical path in a light illuminating unit 400 is illustrated. The light illuminating unit 400 is substantially similar to the light illuminating unit 100 of FIG. 1, except the lateral face 160 is configured to receive LEDs. Thus, any further description of substantially similar elements will be omitted.

The light illuminating unit 400 includes a light guiding plate 400a and a plurality of LEDs 400b. The light guiding plate 400a includes a first light-incident face 410, a second light-incident face 420, a light-exiting face 450 having an effective exiting region 452 and a noneffective exiting region 454, a third light-incident face 460, a first lateral face 470, and a second lateral face 480. The third light-incident face 460 is formed at a position corresponding to the first lateral face 160 of the light illuminating unit 100 in FIG. 1. The third light-incident face 460 is formed adjacent to the second light-incident face 420. The third light-incident face 460 includes a first face 462, a second face 464, and a third face 466. The first face 462 is disposed substantially parallel with respect to a second direction shown in FIG. 8. The second and third faces 464 and 466 are disposed at predetermined angles with respect to the second direction and the first face 462. The LEDs 400b providing the first face 462 with light may be placed at a center portion of the first face 462. The second and third faces 464 and 466 are substantially symmetrical to each other with respect to an axis that passes through a center of the first face 462 where the axis is substantially parallel with the first direction. The LEDs 400b positioned at the first, second, and third faces 462, 464, and 466 of the third light-incident face 460, each emit light incident onto the first, second, and third faces 462, 464, and 466, respectively, of the third light-incident face 460. In the present embodiment, the light-incident face 460 is additionally formed at a position corresponding to the first lateral face 160 of the light illuminating unit 100 in FIG. 1. In an alternative embodiment, the light-incident face 460 may be additionally formed at a position corresponding to the first lateral face 260 of the light illuminating unit 200 in FIG. 5. In yet another alternative embodiment, the light-incident face 460 may be formed at a position corresponding to the first lateral face 360 of the light illuminating unit 300 in FIG. 7. It should be noted that lateral faces 170, 270, and 370 of light illuminating units 100, 200, and 300 of FIGS. 4, 5, and 7, respectively, could also be configured to receive LEDs. According to the present embodiment, the luminance of light emitted from the light-exiting face 450 increases and the uniformity of the light is enhanced.

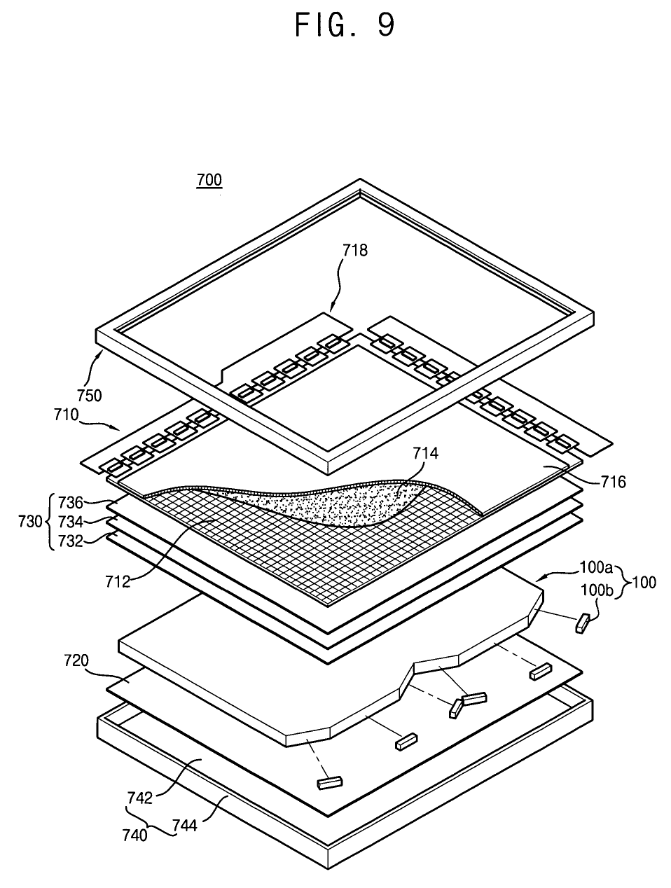

FIG. 9 is an exploded perspective view illustrating an exemplary embodiment of a liquid crystal display device in accordance with the present invention.

Referring to FIG. 9, an LCD device 700 includes a light illuminating unit 100, an LCD panel 710, a reflective sheet 720, an optical member 730, a receiving container 740, and a chassis 750.

The light illuminating unit 100 of FIG. 9 is substantially similar to the light illuminating unit 100 illustrated in FIG. 1. It is contemplated that the LCD device 700 may employ any embodiment of the light illuminating units described in FIGS. 1 to 8.

The LCD panel 710 displays an image using light emitted from the light illuminating unit 100. The LCD panel 710 includes a thin film transistor (“TFT”) substrate 712, a liquid crystal layer 714, a color filter substrate 716, and a driving module 718. The effective exiting region 152 of the light illuminating unit 100 shown in FIG. 4 may be used for an effective display region of the LCD panel 710.

The TFT substrate 712 includes a pixel electrode (not shown), a TFT (not shown), a gate line (not shown), and a data line (not shown). The pixel electrode is arranged in a matrix shape. The TFT applies a driving voltage to the pixel electrode.

The color filter substrate 716 includes a color filter (not shown) and a common electrode (not shown). The color filter corresponds to the pixel electrode. The common electrode is formed on the color filter. The liquid crystal layer 714 is disposed between the TFT substrate 712 and the color filter substrate 716. The driving module 718 drives the LCD panel 710. The reflective sheet 720 is disposed under the light illuminating unit 100.

The reflective sheet 720 reflects light leaking from the light guiding plate 100a toward the reflective sheet 720 into the light guiding plate 100a.

The optical member 730 is disposed over the light illuminating unit 100. The optical member 730 may include a diffusion sheet 732, a prism sheet 734, and a dual brightness enhancement film (“DBEF”) 736. The diffusion sheet 732 enhances the uniformity of the luminance. The prism sheet 734 improves the viewing angle of the displayed image. The DBEF 736 increases the luminance and the viewing angle of the displayed image.

The receiving container 740 receives the light illuminating unit 100, the LCD panel 710, the reflective sheet 720, and the optical member 730. The receiving container 740 includes a bottom plate 742, and a plurality of sidewalls 744. The sidewalls 744 are integrally formed with the bottom plate 742 and protrude from the bottom plate 742 to provide a receiving space.

The chassis 750 is combined with the receiving container 740 surrounding edge portions of the LCD panel 710. The chassis 750 protects the LCD panel 710 from an impact applied to the LCD panel 710. The chassis 750 also prevents drifting of the LCD panel 710.

The LCD device of the present embodiment employs the light illuminating unit of FIG. 1. Alternatively, the LCD device may employ the light illuminating units 200, 300, and 400, in FIGS. 5, 7, and 8, respectively.

According to the present embodiment, the LCD device includes a reduced number of LEDs, thereby simplifying an assembly process and reducing manufacturing cost and power consumption thereof.

Additionally, LEDs are disposed at predetermined angles such that light emitted from each of the LEDs advances in a different direction, thereby reducing a number of the LEDs required to display an image on the LCD panel.

In addition, a noneffective exiting region is reduced when positioning the LEDs as described so that a size of the light illuminating unit and a size of the LCD having the light illuminating unit may be decreased.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A light illuminating unit comprising:
a plurality of light generating members configured to generate light; and
a light guiding plate comprising:
a light-incident face onto which the light is incident;
a lateral face facing the light-incident face; and
a light-exiting face through which the incident light exits, the light-exiting face being configured to connect the light-incident face and the lateral face,
wherein an interval between the light-incident face and the lateral face varies in accordance with a position of each of the light generating members.

2. The light illuminating unit of claim 1, wherein the light generating members comprise a light emitting diode.

3. The light illuminating unit of claim 1, wherein the light-incident face comprises:
a first face disposed substantially parallel with the lateral face;
a second face formed adjacent to a first end portion of the first face, the second face being slanted with respect to the first face; and
a third face formed adjacent to a second end portion of the first face, the third face being slanted with respect to the first face.

4. The light illuminating unit of claim 3, wherein the second and third faces are substantially symmetrical to each other with respect to an axis that passes through a center of the first face, the axis being substantially perpendicular to the first face.

5. The light illuminating unit of claim 3, wherein the light generating members are configured to irradiate the light onto the first face, the second face, and the third face.

6. The light illuminating unit of claim 3, wherein the light generating members are configured to irradiate the light onto the second face and the third face.

7. The light illuminating unit of claim 6, wherein the first face receives substantially no light.

8. The light illuminating unit of claim 1, wherein the light-incident face comprises a first light-incident face and a second light-incident face formed adjacent to the first light-incident face.

9. The light illuminating unit of claim 8, wherein the second light-incident face has a configuration substantially similar to that of the first light-incident face.

10. The light illuminating unit of claim 8, wherein the light-incident face further comprises a third light-incident face.

11. The light illuminating unit of claim 10, wherein the third light-incident face is formed adjacent to the second light-incident face.

12. The light illuminating unit of claim 11, wherein the third light-incident face has a configuration substantially similar to that of the second light-incident face.

13. The light illuminating unit of claim 8, wherein the lateral face is another light-incident face, the lateral face comprising a third light-incident face.

14. The light illuminating unit of claim 13, wherein the lateral face further comprises a fourth light-incident face formed adjacent to the third light-incident face.

15. The light illuminating unit of claim 8, wherein the light guiding plate further comprises:
a first lateral face adjacent to the second light-incident face; and
a second lateral face adjacent to the first light-incident face and facing the first lateral face.

16. The light illuminating unit of claim 15, wherein the first lateral face is a light-incident face, and the first lateral face comprises a third light-incident face.

17. A light illuminating unit comprising:
at least first and second light generating members each of which generates light; and
a light guiding plate having a light-incident face onto which the light is incident and a light-exiting face through which the incident light exits; and
wherein the light-exiting face having an effective exiting region through which the light substantially exits, and the light-incident face having a slanted face such that the light generated from the first light generating member overlaps a portion of light generated from the second light generating member at least when the light enters the effective exiting region.

18. The light illuminating unit of claim 17, wherein the light generating members comprise a light emitting diode.

19. The light illuminating unit of claim 17, wherein the light-incident face comprises:
a first face;
a second face formed adjacent to a first end portion of the first face; and
a third face formed adjacent to a second end portion of the first face.

20. The light illuminating unit of claim 19, wherein the slanted face comprises the second and third faces that are each formed at a selected angle with respect to the first face.

21. The light illuminating unit of claim 20, wherein the second and third faces are substantially symmetrical to each other with respect to an axis that passes through a center of the first face, the axis being substantially perpendicular to the first face.

22. The light illuminating unit of claim 20, wherein the light generating members are configured to irradiate the light onto the first face, the second face, and the third face.

23. The light illuminating unit of claim 20, wherein the light generating members are configured to irradiate the light onto the second face and the third face.

24. The light illuminating unit of claim 23, wherein the light generating members provide substantially no light to the first face.

25. The light illuminating unit of claim 17, wherein the light-incident face comprises a first light-incident face and a second light-incident face formed adjacent to the first light-incident face.

26. The light illuminating unit of claim 25, wherein the light-incident face further comprises a third light-incident face formed adjacent to the second light-incident face.

27. A liquid crystal display device comprising:
a light generating part having a plurality of light generating members configured to generate light;
a light guiding plate comprising:
a light-incident face onto which the light is incident;
a lateral face facing the light-incident face, an interval between the light-incident face and the lateral face varying in accordance with a position of each of the light generating members; and
a light-exiting face through which the incident light exits, the light-exiting face being configured to connect the light-incident face and the lateral face;
a liquid crystal display panel configured to display an image using the light from the light guiding plate; and
a receiving container configured to receive the light generating part, the light guiding plate and the liquid crystal display panel.

28. The liquid crystal display device of claim 27, wherein each of the light generating members comprises a light emitting diode generating the light in response to a voltage signal, and the light generating part further comprises a printed circuit board configured to apply the voltage signal to the light emitting diode.

29. The liquid crystal display device of claim 27, wherein the light-incident face comprises:
a first face disposed substantially parallel with the lateral face;
a second face formed adjacent to a first end portion of the first face, the second face being slanted with respect to the first face; and
a third face formed adjacent to a second end portion of the first face, the third face being slanted with respect to the first face.

30. The liquid crystal display device of claim 27, wherein the light-incident face comprises a first light-incident face and a second light-incident face formed adjacent to the first light-incident face.

31. The liquid crystal display device of claim 30, wherein the light-incident face further comprises a third light-incident face formed adjacent to the second light-incident face.
